(19) United States
(12) Patent Application Publication
(10) Pub. No.: US 2012/0247013 A1
(43) Pub. Date: Oct. 4, 2012

(54) PLANT-GROWING DEVICE WITH LIGHT EMITTING DIODE

(76) Inventor: Chien-Min SUNG, New Taipei City (TW)

(21) Appl. No.: 13/435,695

(22) Filed: Mar. 30, 2012

(30) Foreign Application Priority Data
Apr. 1, 2011 (TW) 100205955

(51) Int. Cl. A01G 1/00; A47G 7/00

(52) U.S. Cl. 47/39; 47/1.1 R

(57) ABSTRACT

A plant-growing device with light emitting diode comprises a darkroom, a generator, a gas collecting device and a water supplying device. The darkroom comprises an accommodating space and a plurality of light emitting diodes disposed in the accommodating space for producing a light beam irradiating the accommodating space. The generator is disposed outside the darkroom. The generator is configured to receive sunlight from the atmospheric environment and convert it into an electric energy and provide the electric energy for the light emitting diodes. The gas collecting device connected between the accommodating space and the atmospheric environment is configured to transfer carbon dioxide from the atmospheric environment into the accommodating space and discharge oxygen from the accommodating space into the atmospheric environment. The water supplying device connected to the darkroom is configured to transport water outside the darkroom into the accommodating space.

### CROSS-REFERENCE TO RELATED APPLICATIONS

This non-provisional application claims priority under 35 U.S.C. §119(a) on Patent Application No(s). 100205955 filed in Taiwan, R.O.C. on Apr. 1, 2011, the entire contents of which are hereby incorporated by reference.

### BACKGROUND

1. Technical Field

The disclosure relates to a plant-growing device with light emitting diode and more particularly to a plant-growing device with light emitting diode which is supplied with electricity by solar energy to operate and can reduce the concentration of carbon dioxide as well as increase the oxygen percentage in the atmospheric environment.

2. Related Art

As the population on Earth increases and the improper development and usage of natural resources continues, arable lands disappear and vegetation on the earth's surface decreases at rapid rates. As a result, the problem of food shortage is getting more serious, the ability of converting carbon dioxide (CO₂) into oxygen (O₂) in the atmospheric environment by photosynthesis is reduced substantially, and the problem of global warming caused by greenhouse effect has gone from bad to worse.

Abnormal climatic changes are caused by the continuously increased temperatures on the earth's surface because of greenhouse effect. The climatic changes are, for examples, the yearly reduction of global rainfall and the reduction of accumulated snow on high mountains both of which result in the shortage of water sources in rivers; the rise of sea level which results in the reduction of land area; the overly concentrated rainfall in regional areas which results in the changes of growing cycles as well as distributions of plants and crops. As a result, plants and crops are seriously affected by floods, droughts, windstorms, plant diseases as well as insect pests. The climatic changes lead to poor harvest of foodstuffs, cause the problems of food shortage and the substantial increase in the prices of raw materials. Even though many countries are aware of the impact of greenhouse effect and have adopted practical measures to cope with it, it is only achieved by reducing the discharge amount of greenhouse gases (e.g. carbon dioxide and methane, etc.).

However, the measures implemented can not cope with the excessive greenhouse gases in the atmospheric environment. Even though there are methods already developed to draw carbon dioxide from the atmosphere, for examples, alkaline aqueous solutions (e.g. alkaline aqueous solution of sodium hydroxide NaOH) are used for drawing carbon dioxide from the atmosphere, the effect is limited and a large amount of chemical reagents has to be used to achieve the purpose, which causes another kind of harmfulness to the atmospheric environment. Currently, with respect to the problem of food shortage caused by greenhouse effect, droughts, floods, plant diseases, insect pests and chilling injury are lightly eased only by developing large area of arable lands or by improving the breeds of plants as well as crops. But the improvement on the breeds of plants and crops is time-consuming. Furthermore, because arable lands on the Earth are limited, large scale cultivation is not feasible even if new breeds of plants and crops are developed successfully. Therefore, food shortage is still a problem which remains unsolved.

### SUMMARY

In view of the above problems, the disclosure provides a plant-growing device with light emitting diode to solve the problem of food shortage caused by the reduction of arable lands as well as plants and crops being affected easily by climatic changes; and the problem of the percentage of greenhouse gases in the atmospheric environment which can not be reduced effectively by the measures implemented.

A plant-growing device with light emitting diode disclosed by the disclosure comprises a darkroom, a generator, a gas collecting device and a water supplying device. The darkroom comprises an accommodating space and a plurality of light emitting diodes disposed in the accommodating space for producing a light beam configured to irradiate the accommodating space. The generator is disposed in an atmospheric environment outside the darkroom. The generator is configured to receive sunlight from the atmospheric environment and convert the sunlight into an electric energy and provide the electric energy for the light emitting diodes. The gas collecting device is connected between the accommodating space and the atmospheric environment. The gas collecting device is configured to transfer carbon dioxide from the atmospheric environment into the accommodating space and discharge oxygen from the accommodating space into the atmospheric environment. The water supplying device is connected to the darkroom. The water supplying device is configured to transport water outside the darkroom into the accommodating space.

The effects of the disclosure are as follows. The darkroom of the plant-growing device with light emitting diode for the growth of plants is disposed underneath ground level or water surface or in a cave in order to avoid being affected by external factors of insect pests, storm damages and chilling injury happened on arable lands on ground level. Therefore, the plants can grow in a stable environment. The plant-growing device with light emitting diode is not easily limited by the area of arable lands, and the plants can be cultivated in large scale to increase the harvest quantities. Light beams produced by the light emitting diodes with certain wavelengths can enhance the photosynthesis of the plants in order to speed up the growth rates and production quantities of plants. Furthermore, because the carbon dioxide in the atmospheric environment is introduced into the darkroom and the oxygen in the darkroom is discharged into the atmospheric environment directly by the plant-growing device with light emitting diode of the disclosure, the oxygen percentage in the atmospheric environment can be increased and the carbon dioxide percentage in the atmospheric environment can be decreased. Thereby, the impact of greenhouse effect on the atmospheric environment can be restrained.

### BRIEF DESCRIPTION OF THE DRAWINGS

The present disclosure will become more fully understood from the detailed description given herein below for illustration only, and thus are not limitative of the present disclosure, and wherein:

FIG. 1 is a side view of a plant-growing device with light emitting diode according to an embodiment of the disclosure; and

FIG. 2 is a side view of the plant-growing device with light emitting diode according to another embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

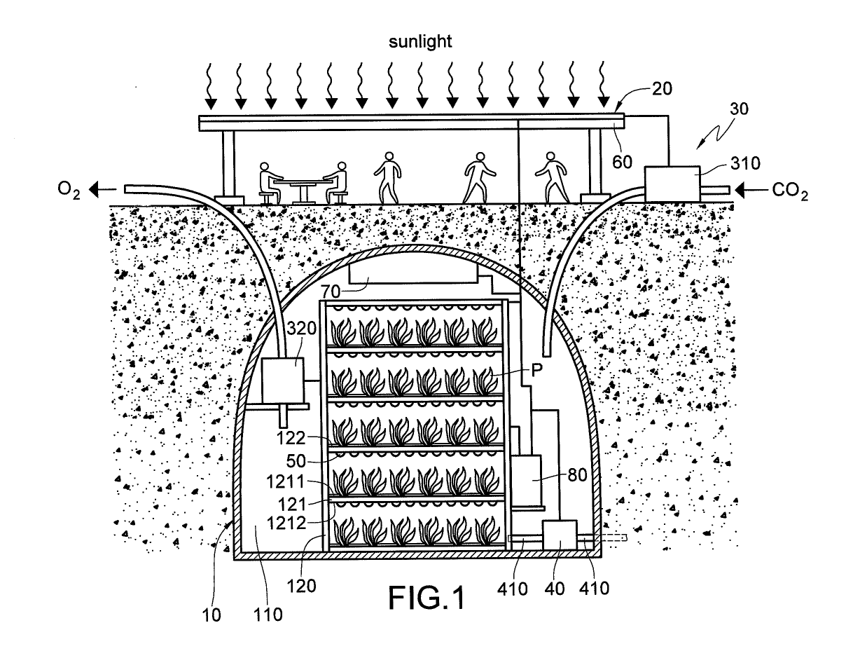

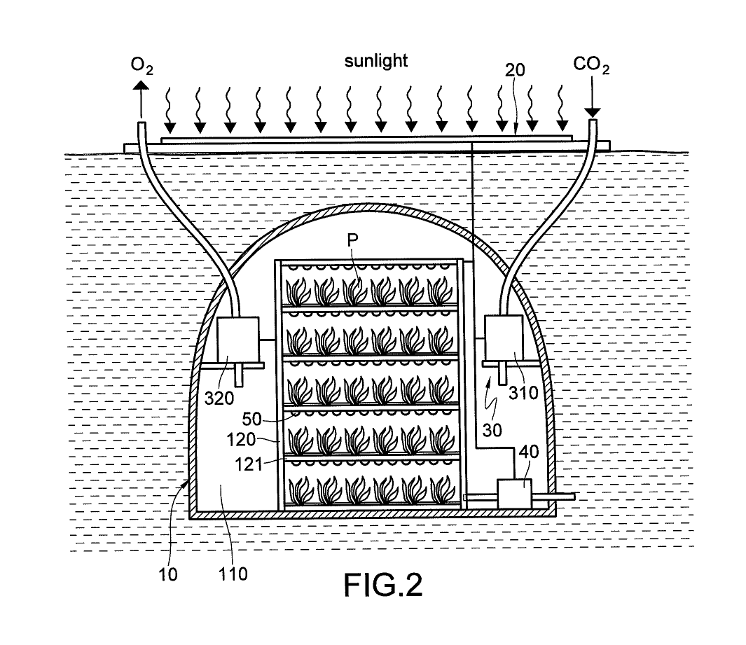

Please refer to FIG. 1, which is an illustration of a plant-growing device with light emitting diode according to an embodiment of the disclosure. The plant-growing device with light emitting diode comprises a darkroom 10, a generator 20, a gas collecting device 30 and a water supplying device 40. The darkroom 10 is, for example, disposed underneath ground level or in a cave. As shown in FIG. 2, in other embodiments of the disclosure, the darkroom 10 is, for example, disposed under water level.

The darkroom 10 has an accommodating space 110. At least one plant growing rack 120 is disposed in the accommodating space 110 for placing and growing plants P. The plant growing rack 120 has a plurality of supporting discs 121, and the supporting discs 121 are disposed at intervals from the top to the bottom of the darkroom 10. Each of the supporting discs 121 has a first surface 1211 and a second surface 1212 opposite to each other. Between two of the adjacent supporting discs 121, the first surface 1211 of one of the supporting discs 121 faces the second surface 1212 of the other supporting disc 121. The plants P are placed and grown on the first surface 1211 of each of the supporting discs 121. Furthermore, the plants P are, for example, planted on the first surfaces 1211 of the supporting discs 121 by means of soil culture or water culture. For examples, the plants P can be planted in pots with soil or in containers with culture solution (not illustrated in the drawings) first, and then the plants P with the pots or containers are placed on the first surfaces 1211 of the supporting discs 121. In some embodiments, the soil can be placed on the first surfaces 1211 of the supporting discs 121. In some embodiments, troughs with culture solution can be disposed on the first surfaces 1211 of the supporting discs 121. The ways of planting the plants P on the supporting discs 121 are not limited to the above embodiments. In other embodiments, the plants P can also be planted on the bottom of the darkroom 10 in order to omit the disposing of the plant growing rack 120.

A plurality of light emitting diodes 50 is disposed on the second surfaces 1212 of the supporting discs 121. The light emitting diodes 50 are, for example, arranged on the second surfaces 1212 of the supporting discs 121 in array arrangement. In order for the light beams produced by the light emitting diodes 50 to be used effectively, solar panels 122 can be disposed on the first surfaces 1211 of the supporting discs 121. Therefore, besides that the light beams produced by the light emitting diodes 50 can be provided for the growth of the plants P, excessive light can be reclaimed by the solar panels 122 so as to enhance the effectiveness of the usage of the light beams.

The chlorophyll of the plants P mainly absorbs blue light with a relatively shorter wavelength and red light with a relatively longer wavelength. In order to enhance the illumination efficiency of light absorbed by the plants P, the light emitted by the light emitting diodes 50 is, for example, blue, red or other colors which has a wavelength range within the spectrum absorbed by the chlorophyll of the plants P. For examples, blue LED (light emitting diode) with the main peak of wavelength within 420 to 520 nm or red LED with the main peak of wavelength within 600 to 720 nm are used for the light emitting diodes 50. In the light-emitting layers of the light emitting diodes 50 composed of metallic compound semiconductors, the metal is, for example, indium (In), or gallium (Ga), or germanium (Ge), or the composition of them; and the compound is, for example, nitrogen (N), or phosphor (P), or arsenic (As), or the composition of them. For examples, when the light with suitable wavelengths emitted by the blue LED composed of nitrides such as indium gallium nitride (InGaN), or by the red LED composed of phosphides such as indium gallium phosphide (In GaP) or arsenides such as indium gallium arsenide (InGaAs), is absorbed by the chlorophyll of the plants P, the percentage of illumination energy used by the plants P can reach at least 10%. Therefore, the efficiency of photosynthesis carried out by the plants P can be enhanced.

The generator 20 is disposed in an atmospheric environment outside the darkroom 10. The generator 20 receives sunlight from the atmospheric environment and converts the solar energy into an electric energy and provides the electric power required for the operation of the plant-growing device with light emitting diode. The generator 20 is a solar cell with multiple P-N junction semiconductors. It is, for example, a flexible thin-film solar cell, such as a copper indium gallium selenium (CIGS) thin-film solar cell. The generator 20 is, for example, installed on the ground, on a surface of a building 60, or supported on a floater (e.g. a floating board) on the water surface. In this embodiment, a flexible thin-film solar cell is used as the generator 20 for disposing on the surface of the building 60 (e.g. an arbor), which is only an example and should not be construed as a limitation to the disclosure.

The gas collecting device 30 comprises a carbon dioxide filter 310 and an oxygen filter 320. The carbon dioxide filter 310 and the oxygen filter 320 are, for example, connected between the accommodating space 110 of the darkroom 10 and the atmospheric environment separately. The carbon dioxide filter 310 is used to draw carbon dioxide in the atmospheric environment and to transfer the carbon dioxide into the accommodating space 110, and the carbon dioxide is provided for the photosynthesis of the plants P. Oxygen produced in the photosynthesis of the plants P is collected by the oxygen filter 320 and is discharged from the accommodating space 110 of the darkroom 10 into the atmospheric environment.

Therefore, carbon dioxide is introduced from the atmospheric environment by the gas collecting device 30, the plants P carry out photosynthesis in the accommodating space 110, and then the oxygen produced by the plants P is discharged from the accommodating space 110 into the atmospheric environment by the gas collecting device 30. Thereby, besides that the carbon dioxide percentage in the atmospheric environment can be reduced, the oxygen percentage in the atmospheric environment is also increased, and the impact of greenhouse effect on the atmospheric environment can be reduced.

The water supplying device 40 is disposed in the accommodating space 110 of the darkroom 10 and is electrically connected to the generator 20. The water supplying device 40 is connected to the plant growing rack 120 via an end of a water transporting pipeline 410, and is connected externally outside the darkroom 10 via another end of the water transporting pipeline 410. Thereby, water from the external environment is transported to the plant growing rack 120 for the growth of the plants P. Alternatively, nutrients such as nitrogen, phosphor, potassium, etc., required for the growth of the plants P are added in the water. In some embodiments, the water is replaced by a culture solution in order to increase the nutrients required for the plants P.

An air conditioning device 70 and an electricity storage device 80 are disposed in the darkroom 10. The air conditioning device 70 and the electricity storage device 80 are electrically connected to the generator 20. The air conditioning device 70 is used to regulate the temperature and humidity inside the accommodating space 110 in order to maintain the growth of the plants P in an environment with suitable temperature and humidity, or is used to control the temperature and humidity for different kinds of the plants P.

The electricity storage device 80 is, for example, electrically connected between the generator 20 and the plant growing rack 120 for storing the electric power produced by the generator 20 and the solar panels 122 of the plant growing rack 120. Therefore, the waste of unused electric power can be avoided. The plant growing rack 120 can be electrically connected to the generator 20 directly in order to obtain power supply, or can be electrically connected to the electricity storage device 80 and then electrically connected to the generator 20 via the electricity storage device 80. The electricity storage device 80 provides electric power for the light emitting diodes 50.

As shown in FIG. 1, when the plant-growing device with light emitting diode is in operation, the accommodating space 110 is provided as a suitable growing environment for the plants P by the coordination of the generator 20, the gas collecting device 30, the water supplying device 40 and the air conditioning device 70, and different adjustments can be made based on the different requirements of the various plants P. Because the plants P are grown in a closed space and the temperature and humidity in the darkroom 10 can be adjusted and controlled by the air conditioning device 70, large amount of water content in the plants P can be prevented from dissipating into the air by evaporation. Therefore, the water content in the plants P can be maintained and the water amount provided by the water supplying device 40 into the darkroom 10 can be saved.

The plants P can obtain stable and adequate illumination by the photoelectric conversion of the generator 20 as well as the light emitting diodes 50. Because the light emitting diodes 50 produce blue and/or red light, the illumination drawing efficiency of the chloroplasts of the plants P can reach at least 10%. Thereby, the efficiency of photosynthesis carried out by the plants P can be enhanced and thus the crop, i.e. the amount of the plants P that is produced, can also be increased. Furthermore, because of the light emitting diodes 50 with different optical wavelengths on the plant growing rack 120, users can deliberately facilitate the growth rate of either leaves or fruits of the plants P in order to increase the crop of the plants P.

Because the carbon dioxide in the atmospheric environment is introduced into the accommodating space 110 of the darkroom 10 and the oxygen in the accommodating space 110 is discharged into the atmospheric environment by the gas collecting device 30, the carbon dioxide percentage in the atmospheric environment is decreased and the oxygen percentage in the atmospheric environment is increased. Thereby, the carbon dioxide and the oxygen in the atmospheric environment are exchanged, so that the impact of greenhouse effect on the natural environment can be reduced.

In some of the embodiments, the darkroom of the plant-growing device with light emitting diode for the growth of plants is disposed underneath ground level or water surface or in a cave, so that external factors such as insect pests, storm damages and chilling injury which affect the growth of plants are avoided. Therefore, the plants can grow in a stable environment. The plant-growing device with light emitting diode is not limited by the reduced area of arable lands, and thus the crop of the plants will not be affected. Light beams produced by the light emitting diodes with certain wavelengths can help the plants to absorb the illumination more effectively and enhance the photosynthesis of plants in order to speed up the growth rates of the plants. Furthermore, because the carbon dioxide in the atmospheric environment is introduced into the darkroom and the oxygen in the darkroom is discharged into the atmospheric environment directly by the plant-growing device with light emitting diode of the disclosure, the exchanging efficiency between the carbon dioxide and the oxygen in the atmospheric environment can be increased substantially. Thereby, the production of greenhouse effect can be reduced effectively.

Note that the specifications relating to the above embodiments should be construed as exemplary rather than as limitative of the present invention, with many variations and modifications being readily attainable by a person of average skill in the art without departing from the spirit or scope thereof as defined by the appended claims and their legal equivalents.

What is claimed is:

1. A plant-growing device with light emitting diode, comprising:
a darkroom comprising an accommodating space and a plurality of light emitting diodes, the light emitting diodes being disposed in the accommodating space for producing a light beam configured to irradiate the accommodating space;
a generator disposed in an atmospheric environment outside the darkroom, the generator being configured to receive sunlight from the atmospheric environment and convert the sunlight into an electric energy and provide the electric energy for the light emitting diodes;
a gas collecting device connected between the accommodating space and the atmospheric environment, the gas collecting device being configured to transfer the carbon dioxide from the atmospheric environment into the accommodating space and discharge the oxygen from the accommodating space into the atmospheric environment; and
a water supplying device connected to the darkroom, the water supplying device is configured to transport a water outside the darkroom into the accommodating space.

2. The plant-growing device with light emitting diode as claimed in claim 1, wherein the darkroom is disposed underneath ground level or water surface or in a cave.

3. The plant-growing device with light emitting diode as claimed in claim 1, wherein the light emitting diodes are blue light emitting diodes and/or red light emitting diodes.

4. The plant-growing device with light emitting diode as claimed in claim 3, wherein the main peak of optical wavelength of the blue light emitting diodes is within 420 to 520 nm.

5. The plant-growing device with light emitting diode as claimed in claim 3, wherein the main peak of optical wavelength of the red light emitting diodes is within 600 to 700 nm.

6. The plant-growing device with light emitting diode as claimed in claim 1, further comprising a plant growing rack disposed in the accommodating space, the light emitting diodes being disposed on the plant growing rack.

7. The plant-growing device with light emitting diode as claimed in claim 6, wherein a plurality of supporting discs is disposed at intervals on the plant growing rack, and each of the supporting discs has a first surface and a second surface opposite to each other, the light emitting diodes are disposed on the second surface of at least one of the supporting discs, and the light beam is irradiated at the first surface of the other supporting disc.

8. The plant-growing device with light emitting diode as claimed in claim 7, further comprising at least one solar panel, the solar panel being disposed on the first surface of the other supporting disc for collecting the light beam.

9. The plant-growing device with light emitting diode as claimed in claim 1, further comprising an electricity storage device electrically connected to the darkroom and the generator, the generator being configured to either store the electric energy in the electricity storage device or supplied the electric energy to the darkroom.

10. The plant-growing device with light emitting diode as claimed in claim 1, further comprising an air conditioning device disposed in the accommodating space for regulating temperature and humidity inside the accommodating space.

11. The plant-growing device with light emitting diode as claimed in claim 1, wherein the generator is a flexible solar cell.

12. The plant-growing device with light emitting diode as claimed in claim 11, wherein the generator is a copper indium gallium selenium thin-film solar cell.

13. The plant-growing device with light emitting diode as claimed in claim 1, wherein each of the light emitting diode has a light emitting layer, the light emitting layer comprises a metallic compound semiconductor, the metallic compound semiconductor comprises a metal and a compound, the metal is made of indium, gallium, germanium or the composition of them, the compound is made of nitrogen, phosphor, arsenic or the composition of them.

14. The plant-growing device with light emitting diode as claimed in claim 13, wherein the metallic compound semiconductor is one of the indium gallium nitride, indium gallium phosphide or indium gallium arsenide.
